(19) United States
(12) Patent Application Publication
(10) Pub. No.: US 2016/0043410 A1
(43) Pub. Date: Feb. 11, 2016

(54) TUBE-TYPE SOLID-OXIDE SECONDARY BATTERY

(71) Applicant: KOREA INSTITUTE OF ENERGY RESEARCH, Yuseong-gu (KR)

(72) Inventors: SUN-DONG KIM, Yuseong-gu (KR); DOO-WON SEO, Yuseong-gu (KR); IN-SUB HAN, Geumsan-gun (KR); SE-YOUNG KIM, Seongnam-si (KR); SANG-KUK WOO, Yuseong-gu (KR)

(21) Appl. No.: 14/818,688

(22) Filed: Aug. 5, 2015

(30) Foreign Application Priority Data
Aug. 6, 2014 (KR) 10-2014-0101049

(51) Int. Cl. H01M 8/00; H01M 4/90; H01M 4/92; H01M 8/04; H01M 4/86

(52) U.S. Cl. CPC H01M 8/004; H01M 8/04089; H01M 8/04291; H01M 4/8621; H01M 4/923; H01M 4/9033; H01M 2008/1293

(57) ABSTRACT

Disclosed is a tube-type solid-oxide secondary battery.

### CROSS REFERENCE TO RELATED APPLICATION

This application claims the benefit of Korean Patent Application No. KR 10-2014-0101049, filed Aug. 6, 2014, which is hereby incorporated by reference in its entirety into this application.

### BACKGROUND OF THE INVENTION

1. Technical Field

The present invention relates to a tube-type solid-oxide secondary battery.

2. Description of the Related Art

The unit cell of a solid oxide fuel cell (hereinafter referred to as a “SOFC”) is configured such that an anode and a cathode are provided on respective sides of an electrolyte having oxygen ion conductivity. When oxygen and hydrogen are supplied to respective electrodes, oxygen ions produced by the reduction reaction of oxygen at the cathode are transported to the anode via the electrolyte and then react with hydrogen supplied to the anode, thereby generating water. As such, in the course of consuming the electrons transported to the cathode from the anode, the electrons may flow to the external circuit, thereby producing electric energy.

The SOFC, elements of which are in a solid phase, is advantageous because it operates at a high temperature of about 600 to 1000° C., exhibits the highest efficiency among various fuel cells, and manifests low pollution, and also because it enables combined power generation, without the need for a fuel reformer. The SOFC may be utilized as a solid oxide electrolyzer cell (SOEC) by a reverse electrochemical reaction.

Meanwhile, a secondary battery is a battery for converting chemical energy into electric energy to supply power to an external circuit, or for converting electric energy supplied from the outside upon discharge into chemical energy to store electricity, and is typically referred to as a storage battery.

Currently commercially available as a non-aqueous electrolyte secondary battery for mobile devices such as mobile phones is a thin lithium ion secondary battery. This kind of battery is configured to include a cathode comprising lithium cobalt oxide (LiCoO₂), an anode comprising a graphite material or a carbonaceous material, a separator comprising a liquid non-aqueous electrolyte including an organic solvent having a lithium salt dissolved therein and a porous membrane, and a jacket comprising a cylindrical or hexahedral metal can.

### SUMMARY OF THE INVENTION

With the goal of realizing dischargeable/rechargeable secondary batteries from conventional SOFCs and SOECs, metal and/or metal oxides must essentially be contained therein. The conventional structure thereof is problematic because the amount of loaded metal powder and the reaction area are small, and thus poor efficiency and capacity may result, undesirably shortening the lifetime of solid-oxide secondary batteries.

Accordingly, an object of the present invention is to provide a solid-oxide secondary battery, in which a metal and/or a metal oxide may be easily loaded, the loaded amount thereof may be maximized, and the lifetime of the secondary battery may be prolonged.

Another object of the present invention is to provide a solid-oxide secondary battery, in which the charge and/or discharge reaction areas are large, and which is easy to seal.

Still another object of the present invention is to provide a solid-oxide secondary battery, in which gas supply and exhaust are easy and in which the number of parts of the device may be remarkably decreased.

In order to accomplish the above objects, the present invention provides a tube-type solid-oxide secondary battery, comprising: a tube-type electrolyte support; a first electrode disposed on the inner wall of the tube-type electrolyte support; a second electrode disposed on the outer wall of the tube-type electrolyte support; and a metal and/or a metal oxide disposed inside the tube-type electrolyte support.

In addition, the present invention provides a tube-type solid-oxide secondary battery, comprising: a tube-type first electrode support; an electrolyte disposed on the outer wall of the tube-type first electrode support; a second electrode disposed on the upper side of the electrolyte; and a metal and/or a metal oxide disposed inside the tube-type first electrode support.

In a preferred embodiment of the present invention, the tube-type solid-oxide secondary battery further comprises a pipe for supplying hydrogen or water vapor into the tube-type electrolyte support and a pipe for exhausting hydrogen or water vapor therefrom.

According to the present invention, a tube-type solid-oxide secondary battery can maximize the amount of metal that is loaded, effectively increasing the lifetime of the secondary battery.

Also, the secondary battery is provided in the form of a tube shape, thus enlarging the charge or discharge reaction area and facilitating the sealing thereof

Furthermore, gas supply and exhaust become easy, and the number of parts of the device can be remarkably decreased.

### BRIEF DESCRIPTION OF THE DRAWINGS

The above and other objects, features and advantages of the present invention will be more clearly understood from the following detailed description taken in conjunction with the accompanying drawings, in which:

FIG. 1 schematically illustrates a tube-type solid-oxide secondary battery according to an embodiment of the present invention during the discharge;

FIG. 2 schematically illustrates the reaction of the region indicated by the dotted line in FIG. 1;

FIG. 3 schematically illustrates a tube-type solid-oxide secondary battery according to an embodiment of the present invention during the charge;

FIG. 4 schematically illustrates the reaction of the region indicated by the dotted line in FIG. 3;

FIG. 5 schematically illustrates a tube-type solid-oxide secondary battery according to an embodiment of the present invention during the discharge; and

FIG. 6 schematically illustrates a tube-type solid-oxide secondary battery according to an embodiment of the present invention during the charge.

### DESCRIPTION OF THE SPECIFIC EMBODIMENTS

Hereinafter, a detailed description will be given of the present invention. The following description is directed to embodiments of the present invention, and is not to be construed as limiting the scope of the present invention, which is to be defined by the claims, even if there are limiting expressions.

In order to obtain a dischargeable/chargeable secondary battery from a conventional SOFC and SOEC, a metal and/or a metal oxide must be contained therein, but the amount of metal that is loaded and the reaction area are small in the conventional structure, undesirably resulting in limited efficiency and capacity. Thereby, the solid-oxide secondary battery is problematic because of its short lifetime.

Therefore, the present inventors have devised a solid-oxide secondary battery manufactured in the form of a tube shape, thereby solving the above problems, ultimately culminating in the present invention.

Therefore, the present invention addresses a tube-type solid-oxide secondary battery, comprising: a tube-type electrolyte support; a first electrode disposed on the inner wall of the tube-type electrolyte support; a second electrode disposed on the outer wall of the tube-type electrolyte support; and a metal or a metal oxide disposed inside the tube-type electrolyte support.

In a preferred embodiment of the present invention, the tube-type solid-oxide secondary battery further comprises a pipe for supplying hydrogen or water vapor into the tube-type electrolyte support and a pipe for exhausting hydrogen or water vapor therefrom.

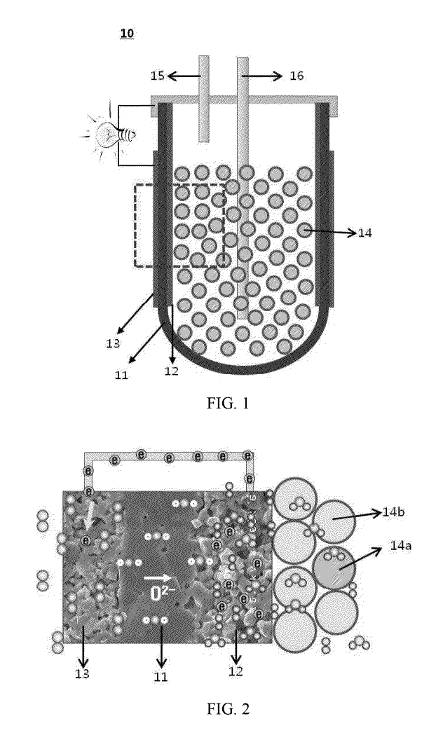

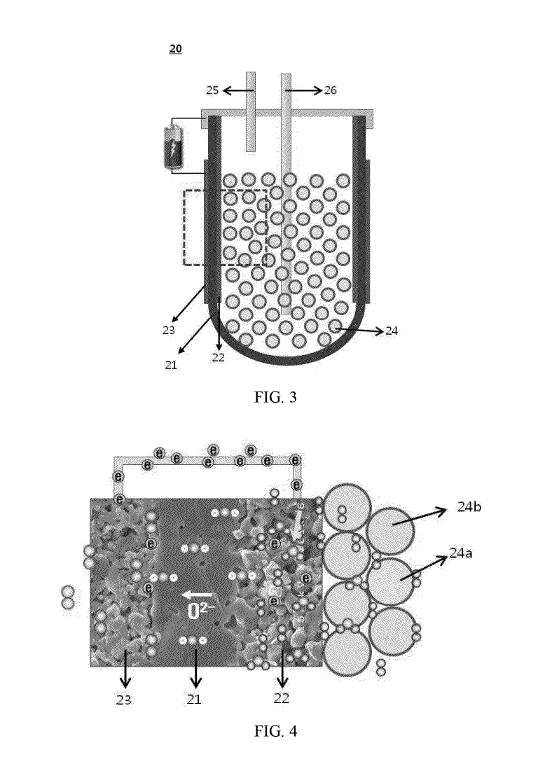

FIG. 1 schematically illustrates a tube-type solid-oxide secondary battery according to the present invention during the discharge, FIG. 2 schematically illustrates the reaction of the region indicated by the dotted line in FIG. 1, FIG. 3 schematically illustrates a tube-type solid-oxide secondary battery according to the present invention during the charge, and FIG. 4 schematically illustrates the reaction of the region indicated by the dotted line in FIG. 3.

As illustrated in FIGS. 1 and 2, and 3 and 4, the tube-type solid-oxide secondary battery comprises a tube-type electrolyte support 11, 21, a first electrode 12, 22 disposed on the inner wall of the tube-type electrolyte support, a second electrode 13, 23 disposed on the outer wall of the tube-type electrolyte support, and a metal 14b, 24a and/or a metal oxide 14a, 24b disposed inside the tube-type electrolyte support. Further, in FIG. 1, a pipe 15 for supplying hydrogen into the tube-type electrolyte support and a pipe 16 for exhausting water vapor therefrom are provided. In FIG. 3, a pipe 25 for supplying water vapor into the tube-type electrolyte support and a pipe 26 for exhausting hydrogen therefrom are provided.

In a preferred embodiment of the present invention, a device for supplying hydrogen or water vapor to the first electrode and a device for supplying oxygen or air to the second electrode are provided.

Referring to the drawings, individual constituents are described below.

The tube-type electrolyte support 11, 21 is first described below.

In the present invention, the electrolyte functions as a transport path of oxygen ions in the reaction of the secondary battery. Also, as the electrolyte is provided in the form of a tube shape, it may play a role as a support for the secondary battery.

In the electrolyte support, the electrolyte may be used without limitation so long as it is typically useful in SOFCs, and preferably includes any one or more selected from among zirconia-, ceria-, bismuth-based materials, and LaGaO₃. For example, YSZ, GDC and LSGM may be adopted.

Also, the electrolyte is manufactured using a conventional fuel cell process, whereby it may be provided in a tube shape. When the electrolyte support is provided in a tube shape in this way, the metal or the metal oxide may be easily loaded inside the support, and the loaded amount thereof may be maximized. Furthermore, a large reaction area may result.

Moreover, gas supply and exhaust become easy, and the number of parts of the device may be remarkably decreased.

Next, the first electrode 12, 22 disposed on the inner wall of the tube-type electrolyte support is described below.

In the first electrode according to the present invention, the supplied hydrogen plays a role in emitting electrons during the discharge, as represented in the reaction scheme of FIG. 2. The related reaction is shown in the following Reaction 1.

FIG. 2 schematically illustrates the reaction of the region indicated by the dotted line during the discharge of FIG. 1.

Discharge 1^{st} step: H₂+O²⁻=H₂O+2e⁻ [Reaction 1]

At the first electrode, while charging, water receives electrons and thus decomposes to hydrogen, as represented in the reaction scheme of FIG. 4. The related reaction is shown in the following Reaction 2.

FIG. 4 schematically illustrates the reaction of the region indicated by the dotted line in FIG. 3.

Charge 1^{st} step: H₂O+e⁻=H₂+O²⁻ [Reaction 2]

For the first electrode, any material may be used without limitation, and an example thereof may include at least one selected from among NiO, a mixture of NiO and YSZ, a mixture of NiO and GDC (Gd-doped CeO₂), and a precious metal stable to oxidation and reduction. Preferably useful as the precious metal is Pt.

Next, the second electrode 13, 23 disposed on the outer wall of the tube-type electrolyte support is described below.

In the second electrode according to the present invention, a reduction reaction of oxygen by the supplied oxygen or air proceeds during the discharge, as represented in the reaction scheme of FIG. 2. The related reaction is shown in the following Reaction 3.

½O₂+2e⁻→O²⁻ [Reaction 3]

While charging, a reaction of emitting oxygen via the oxidation of oxygen ions is carried out, as represented in the reaction scheme of FIG. 4. The related reaction is shown in the following Reaction 4.

O²⁻→½O₂+2e⁻ [Reaction 4]

For the second electrode, any material may be typically used without limitation, and an example thereof may include at least one selected from among LSM, LSC, LSCF, LSCF-GDC, and a precious metal stable to oxidation and reduction. Preferably useful as the precious metal is Pt.

In a preferred embodiment of the present invention, each of the first electrode and the second electrode is porous.

Next, the metal 14b, 24a and/or the metal oxide 14a, 24b disposed inside the tube-type electrolyte support or the first electrode support are described below.

According to the present invention, the metal or the metal oxide functions to store and emit energy by oxidation and reduction in the tube-type solid-oxide secondary battery. In the discharge reaction, the loaded metal 14b is converted into a metal oxide 14a by water vapor produced at the first electrode, thus forming the flow of electrons. Also, discharge takes place until all of the loaded metals are converted into metal oxides, and the reaction scheme thereof is shown in FIG. 2. The related reaction is represented in the following Reaction 5.

Discharge 2^{nd} step: Me+xH₂O=MeOx+xH₂ [Reaction 5]

As opposed to the discharge reaction, the charge reaction is carried out in a manner such that the loaded metal oxide 24b is reduced to a metal 24a by hydrogen generated at the first electrode, and proceeds until all of the metal oxides are converted into metals. The reaction scheme thereof is shown in FIG. 4, and the related reaction is represented in the following Reaction 6.

Charge 2^{nd} step: MeOx+xH₂=Me+xH₂O [Reaction 6]

In a preferred embodiment of the present invention, the metal is usable without limitation so long as oxidation and reduction can be reversibly carried out, and examples thereof may include Ni, Fe and so on.

In addition, the present invention addresses a tube-type solid-oxide secondary battery, comprising: a tube-type first electrode support; an electrolyte disposed on the outer wall of the tube-type first electrode support; a second electrode disposed on the upper side of the electrolyte; and a metal and/or a metal oxide disposed inside the tube-type first electrode support.

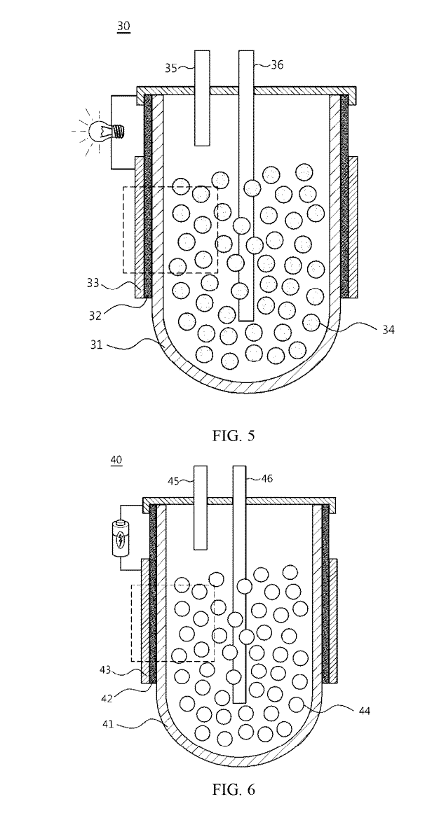

FIG. 5 schematically illustrates a tube-type solid-oxide secondary battery according to the present invention during the discharge, and FIG. 6 schematically illustrates a tube-type solid-oxide secondary battery according to the present invention during the charge.

As illustrated in FIGS. 5 and 6, the tube-type solid-oxide secondary battery comprises a tube-type first electrode support 31, 41, an electrolyte 32, 42 disposed on the outer wall of the tube-type first electrode support, a second electrode 33, 43 disposed on the upper side of the electrolyte, and a metal and/or a metal oxide 34, 44 disposed inside the tube-type first electrode support. Further, FIG. 5 shows a pipe 35 for supplying hydrogen into the tube-type first electrode support and a pipe 36 for exhausting water vapor therefrom, and FIG. 6 shows a pipe 45 for supplying water vapor into the tube-type first electrode support and a pipe 46 for exhausting hydrogen therefrom.

In a preferred embodiment of the present invention, there is provided a tube-type solid-oxide secondary battery, further comprising a pipe for supplying hydrogen or water vapor into the tube-type first electrode support and a pipe for exhausting hydrogen or water vapor therefrom.

Furthermore, each of the first electrode support and the second electrode may be porous.

In a preferred embodiment of the present invention, a device for supplying hydrogen or water vapor to the first electrode support and a device for supplying oxygen or air to the second electrode are included.

The description of the first electrode, the electrolyte, the second electrode, the metal or the metal oxide, the pipe for supplying hydrogen or water vapor, and the pipe for exhausting hydrogen or water vapor may remain the same as in the aforementioned description.

Consequently, the tube-type solid-oxide secondary battery according to the present invention includes a tube-type support, thus maximizing the amount of metal that can be loaded, thereby effectively prolonging the lifetime of the secondary battery. Also, the secondary battery is provided in the form of a tube shape, thus enlarging the charge or discharge reaction area and facilitating the sealing of the battery.

Moreover, gas supply and exhaust become easy, and the number of parts of the device may be remarkably decreased.

Although the preferred embodiments of the present invention have been disclosed for illustrative purposes, those skilled in the art will appreciate that various modifications and other equivalent embodiments are possible from the embodiments. Therefore, the technical scope of the present invention should be defined by the technical spirit of the claims.

What is claimed is:

1. A tube-type solid-oxide secondary battery, comprising:
a tube-type electrolyte support;
a first electrode disposed on an inner wall of the tube-type electrolyte support;
a second electrode disposed on an outer wall of the tube-type electrolyte support; and
a metal and/or a metal oxide disposed inside the tube-type electrolyte support.

2. A tube-type solid-oxide secondary battery, comprising:
a tube-type first electrode support;
an electrolyte disposed on an outer wall of the tube-type first electrode support;
a second electrode disposed on an upper side of the electrolyte; and
a metal and/or a metal oxide disposed inside the tube-type first electrode support.

3. The tube-type solid-oxide secondary battery of claim 1, further comprising a pipe for supplying hydrogen or water vapor into the tube-type electrolyte support and a pipe for exhausting hydrogen or water vapor therefrom.

4. The tube-type solid-oxide secondary battery of claim 2, further comprising a pipe for supplying hydrogen or water vapor into the tube-type first electrode support and a pipe for exhausting hydrogen or water vapor therefrom.

5. The tube-type solid-oxide secondary battery of claim 1, wherein the first electrode comprises at least one selected from among NiO, a mixture of NiO and YSZ, a mixture of NiO and GDC (Gd-doped CeO₂), and a precious metal stable to oxidation and reduction.

6. The tube-type solid-oxide secondary battery of claim 5, wherein the precious metal is Pt.

7. The tube-type solid-oxide secondary battery of claim 2, wherein the first electrode support comprises at least one selected from among NiO, a mixture of NiO and YSZ, a mixture of NiO and GDC (Gd-doped CeO₂), and a precious metal stable to oxidation and reduction.

8. The tube-type solid-oxide secondary battery of claim 7, wherein the precious metal is Pt.

9. The tube-type solid-oxide secondary battery of claim 1, wherein the second electrode comprises at least one selected from among LSM, LSC, LSCF, LSCF-GDC, and a precious metal stable to oxidation and reduction.

10. The tube-type solid-oxide secondary battery of claim 2, wherein the second electrode comprises at least one selected from among LSM, LSC, LSCF, LSCF-GDC, and a precious metal stable to oxidation and reduction.

11. The tube-type solid-oxide secondary battery of claim 1, wherein each of the first electrode and the second electrode is porous.

12. The tube-type solid-oxide secondary battery of claim 2, wherein each of the first electrode support and the second electrode is porous.

13. The tube-type solid-oxide secondary battery of claim 1, further comprising a device for supplying hydrogen or water vapor to the first electrode, and a device for supplying oxygen or air to the second electrode.

14. The tube-type solid-oxide secondary battery of claim 2, further comprising a device for supplying hydrogen or water vapor to the first electrode support, and a device for supplying oxygen or air to the second electrode.
